(19) United States
(12) Patent Application Publication
(10) Pub. No.: US 2014/0108448 A1
(43) Pub. Date: Apr. 17, 2014

(54) MULTI-SENSOR VELOCITY DEPENDENT CONTEXT AWARE VOICE RECOGNITION AND SUMMARIZATION

(71) Applicant: INTEL CORPORATION, Santa Clara, CA (US)

(72) Inventors: Kevin Jay Daniel, Tigard, OR (US); Willem Marinus Beltman, West Linn, OR (US)

(21) Appl. No.: 13/995,395

(22) PCT Filed: Mar. 30, 2012
(86) PCT No.: PCT/US12/31399

§ 371 Date: Jun. 18, 2013

(51) Int. Cl. G06F 17/30

(52) U.S. Cl. CPC G06F 17/30424
USPC 707/769

(57) ABSTRACT

A system and method for receiving an indication of an environmental context; receiving a query request; determining a query result in reply to the query request based, at least in part, on the environmental context; and presenting the query result in a format depending on the environmental context.

### BACKGROUND

Speech recognition engines have been developed in part to provide a mechanism for machines to receive input in the form of spoken words or speech from humans. In some instances, a person may interact with a machine in a manner that is more intuitive than entering text and/or selecting one or more controls of the machine since interaction between humans using speech is a natural occurrence. A further development in the field of speech recognition includes natural language processing methods and devices. Such methods and devices include functionality to process speech that is received in a “natural” format as typically spoken between humans, without restrictive command-like input constraints.

While speech recognition and natural language processing methods may ease the interaction between humans and machines to an extent, machines (e.g., computers) including conventional speech recognition methods and systems typically provide fixed response formats based on static settings and/or capabilities of the machine. As an example, a mobile device including voice recognition functionality may receive a spoken search request for directions, wherein the mobile device will determine the directions and provide the results in the form of spoken speech. In this scenario, the request for directions may be determined, in part, based on the location of the mobile device. However, how the search for directions is executed or the directions are presented are not based on the velocity or any other specific conditions of the device. Improving the efficiency of speech recognition and natural language processing methods is therefore seen as important.

### BRIEF DESCRIPTION OF THE DRAWINGS

Aspects of the present disclosure herein are illustrated by way of example and not by way of limitation in the accompanying figures. For purposes related to simplicity and clarity of illustration rather than limitation, aspects illustrated in the figures are not necessarily drawn to scale. Further, where considered appropriate, reference labels have been repeated among the figures to indicate corresponding or analogous elements.

FIG. 1 is a flow diagram of a process, in accordance with an embodiment herein.

FIG. 2 is a flow diagram of a process related to a search request and an environmental context, in accordance with one embodiment.

FIG. 3 illustrates a tabular listing of various parameters of a method and system, in accordance with an embodiment.

FIG. 4 is an illustrative depiction of a system, in accordance with an embodiment herein.

FIG. 5 illustrates a block diagram of a speech recognition system in accordance with some embodiments herein.

### DETAILED DESCRIPTION

The following description describes a method or system that may support processes and operation to improve efficiency of speech recognition systems by providing a mechanism to facilitate context aware speech recognition and summarization. The disclosure herein provides numerous specific details such regarding a system for implementing the processes and operations. However, it will be appreciated by one skilled in the art(s) related hereto that embodiments of the present disclosure may be practiced without such specific details. Thus, in some instances aspects such as control mechanisms and full software instruction sequences have not been shown in detail in order not to obscure other aspects of the present disclosure. Those of ordinary skill in the art will be able to implement appropriate functionality without undue experimentation given the included descriptions herein.

References in the present disclosure to “one embodiment”, “some embodiments”, “an embodiment”, “an example embodiment”, “an instance”, “some instances” indicate that the embodiment described may include a particular feature, structure, or characteristic, but that every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Some embodiments herein may be implemented in hardware, firmware, software, or any combinations thereof. Embodiments may also be implemented as executable instructions stored on a machine-readable medium that may be read and executed by one or more processors. A machine-readable storage medium may include any tangible non-transitory mechanism for storing information in a form readable by a machine (e.g., a computing device). In some aspects, a machine-readable storage medium may include read only memory (ROM); random access memory (RAM); magnetic disk storage media; optical storage media; flash memory devices; and electrical and optical forms of signals. While firmware, software, routines, and instructions may be described herein as performing certain actions, it should be appreciated that such descriptions are merely for convenience and that such actions are in fact result from computing devices, processors, controllers, and other devices executing the firmware, software, routines, and instructions.

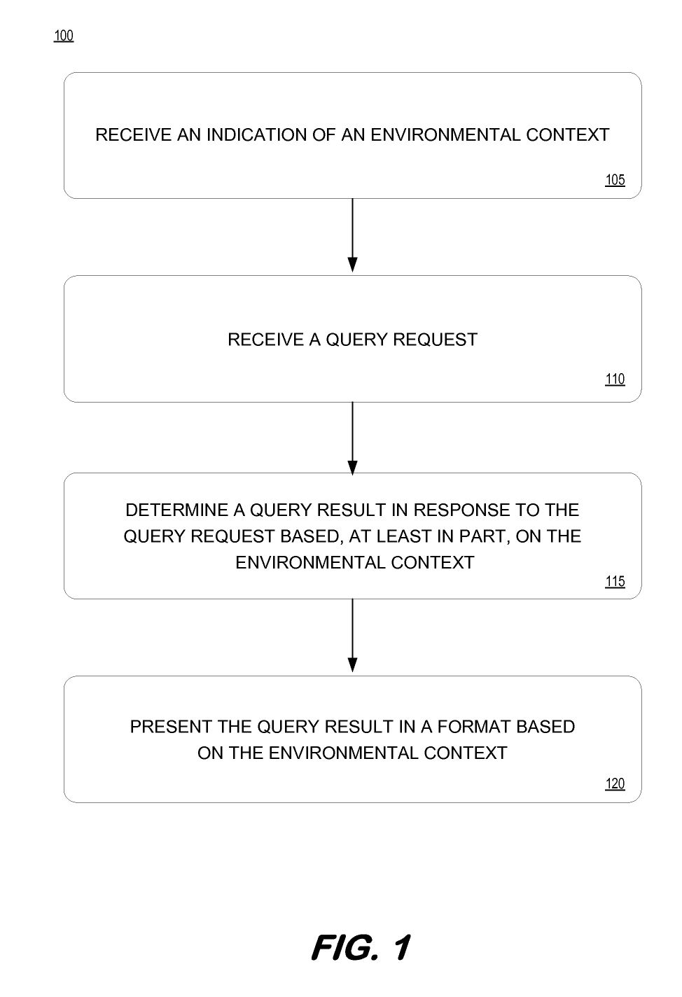

FIG. 1 is an illustrative flow diagram of a process 100 in accordance with an embodiment herein. At operation 105, an indication of an environmental context is received. As used herein, the environmental context may relate to a device, system, or person associated with the device or system. For example, the device or system may be a portable device such as, but not limited to, a smartphone, a tablet computing device, or other mobile computing/processing device. In some aspects, the device or system may include or form part of another device or system such as, for example, a navigation/entertainment system of a motor vehicle. More particularly, the environmental context may refer to a velocity, an activity, and a combination of the velocity and activity for the related device, system, or person associated with the device or system. In some aspects, a person may be considered associated with the device or system by virtue of being in close proximity with the device or system.

The indication of the environmental context may be based on signals or other indicators provided by one or more environmental sensors. An environmental sensor may be any type of sensor, now known and those that may become known in the future, that are capable of providing an indication or signal that indicates or can be used in determining an indication of the environmental context of a device, system, and person. In some embodiments herein, the environmental sensors may include at least one of a light sensor, a position sensor, a microphone, an accelerometer, a gyroscope, a global positioning satellite sensor (all varieties), a temperature sensor, a barometric pressure sensor, a proximity sensor, an altimeter, a magnetic field sensor, a compass, an image sensor, a bio-feedback sensor, and combinations thereof, as well as other types of sensors not specifically listed.

In some aspects, signals from the environmental sensor(s) may be used to determine a velocity, an activity, and a combination of the location and activity (i.e., environmental context) for the related device, system, or person. By determining the velocity, activity, or a combination of the location and activity for a related device, system, or person, one may use such a determination to provide a more efficient method and system as discussed below.

At operation 110, a request is received. In some aspects, the request may be a query or other type of request for information that may be received via a speech recognition functionality of a device or system. In some aspects, the query may be received directly from a person as a result of a specific inquiry. In some other aspects, the query may be received as a periodic request such as, for example, a pre-recorded or previously indicated request.

At operation 115, a query result is determined in response to the query request based, at least in part, on the environmental context. As such, the query result determined in reply to the query request may consider the environmental context in the determination of the query result. Accordingly, the query result determination may be made based on the environmental context. In some embodiments, the speed at which the query result is obtained and the level of detail included in the query result may be dependent on the environmental context. As an example, the speed of the query result determination and/or the level of detail included in the query result may depend on the velocity and the activity (i.e., the environmental context) of the device, system, or person associated with the device or system.

At operation 120, the query result is presented in a format corresponding to the environmental context. In some instances the presentation of the query result may be made via visual presentation such as a screen, monitor, video readout, or other display device or the presentation may be audible presentation such as a spoken presentation of the query result via a speaker.

As depicted, process 100 includes a determination and presentation of a query result or other information that is based, at least in part, based on an environmental context of a device, system, or person associated with the device or system. In some instances, process 100 may comprise part of a larger or other process (not shown) including more, fewer, or other operations.

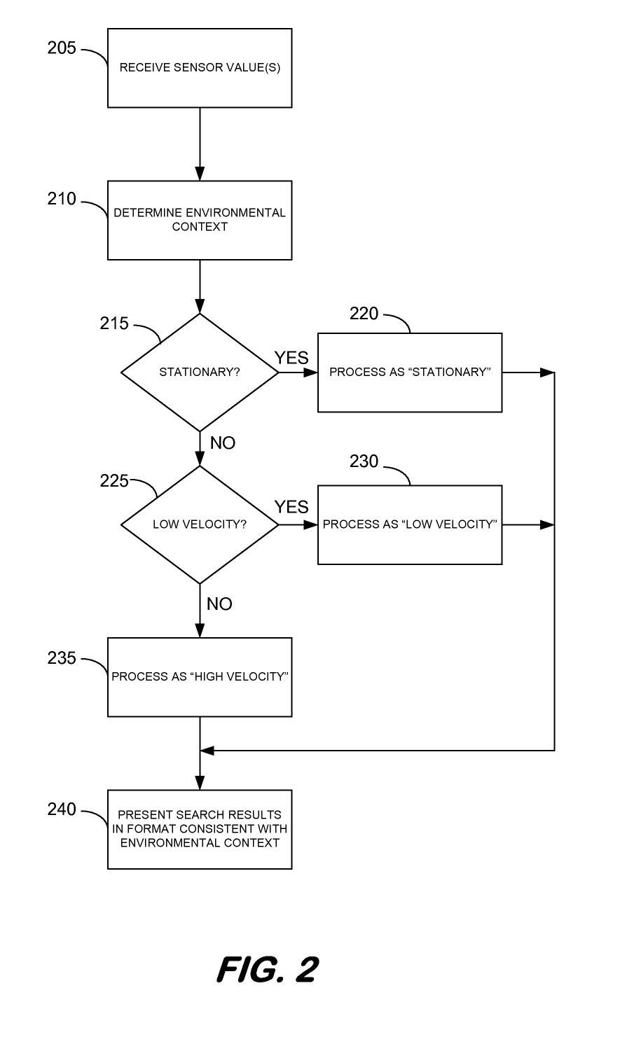

FIG. 2 provides an illustrative depiction of a flow diagram 200 related to some embodiments herein. As an overview, process 200 operates to determine and categorize an environmental context associated with a device, system, or person. At operation 205, sensor signals or indications of values associated with one or more environmental sensors is received. The sensor values may be received in a signal via any type of communication configured for any type of protocol without limit, whether wired or wireless.

At operation 210, the sensor values received at 205 may be used to determine an environmental context in accordance with the present disclosure. Process 200 continues to operation 215 to categorize the environmental context of a device or system based on the received sensor values. At 215, a determination is made whether the environmental context, as based on the received sensor signals, is indicative of a stationary activity or near stationary activity. A stationary activity may include for example any activity where the device, system, or person associated with the device or system is moving less than a minimum or threshold speed.

In the event operation 215 determines the environmental context is stationary, then process 200 proceeds to operation 220 where the query is processed for a “stationary” result. In the event operation 215 determines the environmental context is not stationary, then process 200 proceeds to operation 225. At operation 225, a determination is made whether the environmental context is a “low velocity activity”. In the event operation 225 determines the environmental context is a low velocity activity, then process 200 proceeds to operation 230 where the query is processed for a “low velocity activity” result. In the event operation 225 determines the environmental context is not a low velocity activity, then process 200 proceeds to operation 235. At operation 235, the query is processed for a “high velocity activity” result since it has been determined that the environmental context is neither a stationary (215) nor low velocity activity (225).

In some embodiments, the processing of the query for the “stationary” activity at operation 220 may be accomplished without any specific or restrictive limit regarding time of the processing time. For example, the processing of the query for a result may be limited to the capabilities of a particular search engine used as opposed to any additional limits or considerations made in connection with process 200. In contrast, the processing of the query for the “low velocity” activity at operation 230 may be limited to some time period to accommodate the low velocity environmental context determined at operation 225. That is, since the device, system, or person associated with the device or system may be engaged in some activity that includes moving at a “low velocity”, then the user may desire to have the result in a relatively quick time frame. Regarding the processing of the query for the “high velocity” activity at operation 235, a time limit for the processing of the query may be more limited as compared to operation 230 and 220 to accommodate the high velocity environmental context determined at operation 225. Accordingly, since the device, system, or person associated with the device or system may be engaged in some activity that includes moving at a “high velocity”, then the user's attention may be focused on the high velocity activity with which they are engaged. As such, they may desire to have the result in a very quick or near instantaneous time frame.

At operation 240, process 200 operates to present the query result determined at 220, 230, or 235 in a format that is consistent with the determined environmental context activity level. For example, in the event it is determined the activity is a stationary activity such as a person sitting at their desk at work, then the query result may include a result including many details that may be presented in a message (SMS, email, or other message types) and spoken to the person. As another example, for a low velocity activity such as a person jogging or walking, then the query result may include a result having a moderate amount of details that may be presented in a message (SMS, email, or other message types) and spoken to the person. The “low velocity” activity results may typically contain less than the number and extent of details included in the “stationary” activity results determined at operation 220. In the event that the environmental context determined in process 200 indicates a “high velocity” activity such as a person driving a car or cycling, then the query result may include a result that includes relatively few details, whether presented in a message (SMS, email, or other message types) and/or spoken to the person via a speech recognition system.

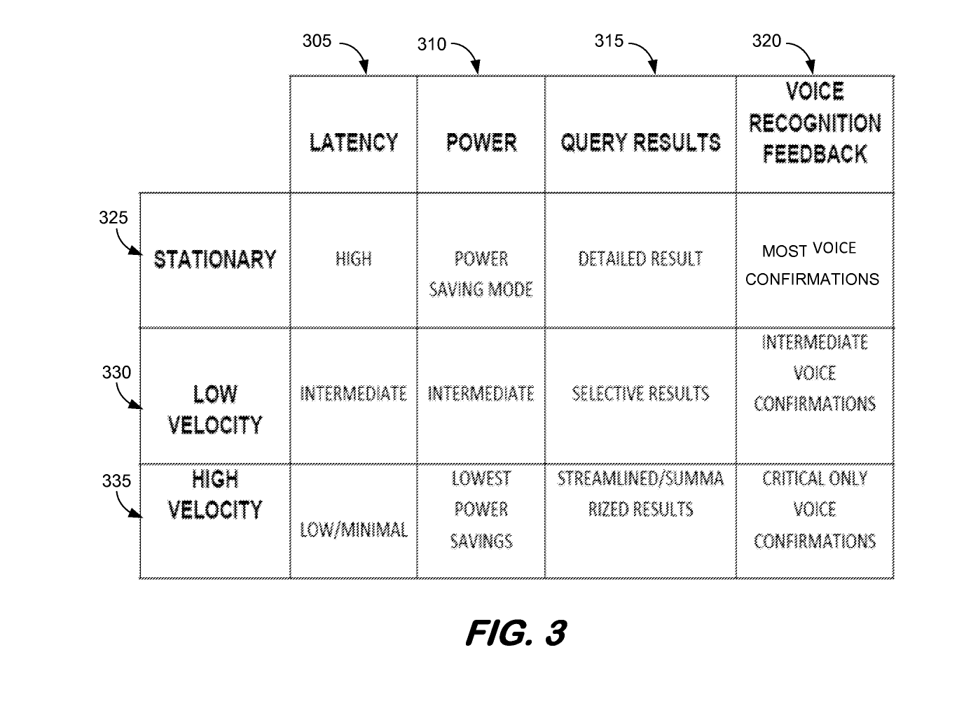

FIG. 3 is an illustrative depiction of a table 300, that summarizes multiple types of environmental contexts (325, 330, and 335) and the values for parameters (305, 310, 315, and 320) associated with each environmental context. As illustrated in table 300, a “stationary” activity may be associated with a query result determination having a high latency and using a power saving mode of operation (i.e., low power usage) to provide a detailed result that may be characterized by extensive voice recognition interactions. The detailed result for the stationary environmental context 325 context may include more details as compared to the other environmental contexts 330 and 335.

Table 300 also illustrates a “low velocity” activity environmental context 330 that may be associated with a query result determination having a relative intermediate latency while using an intermediate power mode of operation (e.g., balanced power usage) to provide a result that includes selective details. The selective details may include details considered most relevant, while omitting lesser details. This result category may offer some selective voice recognition feedback or interaction.

Table 300 further illustrates a high velocity activity environmental context at 335 that may be associated with a query result determination having a relatively low(est) latency while using a low(est) power saving mode (i.e., high power usage) of operation to provide a result that includes relatively few details. The relatively few details may constitute a brief summarization and include only the most relevant or information. This result category may offer very little or no voice recognition feedback or interaction.

It should be recognized that table 300, as well as the processes of FIGS. 1 and 3, is provided for illustrative purposes and may include more, alternative, or fewer environmental context categorizations than those specifically shown in table 300. Table 300 may also be expanded or contracted to include more, alternative, or fewer parameters than those specifically depicted in the illustrative example of FIG. 3.

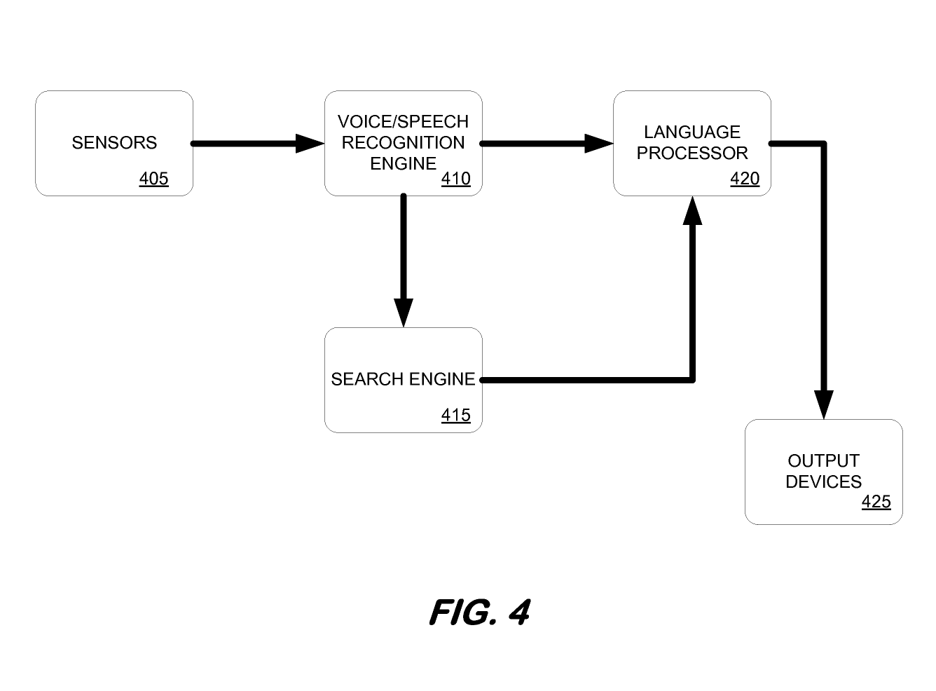

FIG. 4 is a depiction of a block diagram illustrating a system 400 in accordance with an embodiment herein. System 400 includes one or more environmental sensors 405. Sensors 405 may operate to provide a signal or other indication of a value associated with a particular environmental parameter. System 400 also includes a speech recognition system 410, a search engine 415, a language processor 420, and output device(s) 425.

Sensors 405 may include one or more of a microphone, a global satellite positioning system (GPS) sensor, an accelerometer, and other sensors as discussed herein. In the example of FIG. 4, the microphone may detect an ambient or background noise level, the GPS sensor may detect/determine a location of the device or system, and the accelerometer may detect a velocity of the device or system. The speech recognition engine may receive a spoken query or other request for information (e.g., directions, information regarding places of interest, etc.) and the search engine 415 may operate to determine a response to the query request, based in part on the environmental context indicated by the environmental sensors 405. The search engine may use resources, such as databases, processes, and processors, internal to a device or system and it may interface with a separate device, network or service for the query result. The query result may be processed by language processor 420 to configure the search result as speech for presentation to a user.

At 425, the query result may be presented in a format that is consistent with the determined environmental context. In some embodiments, the search results may be presented via a display device or a speaker in the instance the query result is presented as speech. For example, results for a “stationary” activity may be presented via a display device with (or without) an extensive number of voice prompts and interactive cues requesting a user's reply. Since the activity of the user is stationary, the user may have sufficient time to receive detailed results and interact with the speech recognition aspects of the device or system. In an instance the environmental context is determined to be, for example, a “low velocity” activity or a “high velocity activity” then the query result may be presented via a display output device with (or without) a number of voice prompts and interactive cues requesting a user's reply, where the details included in the search result and the extent of voice interactions is dependent on and commensurate the specific environmental context as disclosed herein (e.g., FIG. 3).

In some embodiments, the methods and systems herein may automatically determine the search results based, at least in part, on the environmental context associated with a device, system, or person. In some embodiments, the methods and systems herein may automatically present the search results and other information based, at least in part, on the environmental context associated with a device, system, or person.

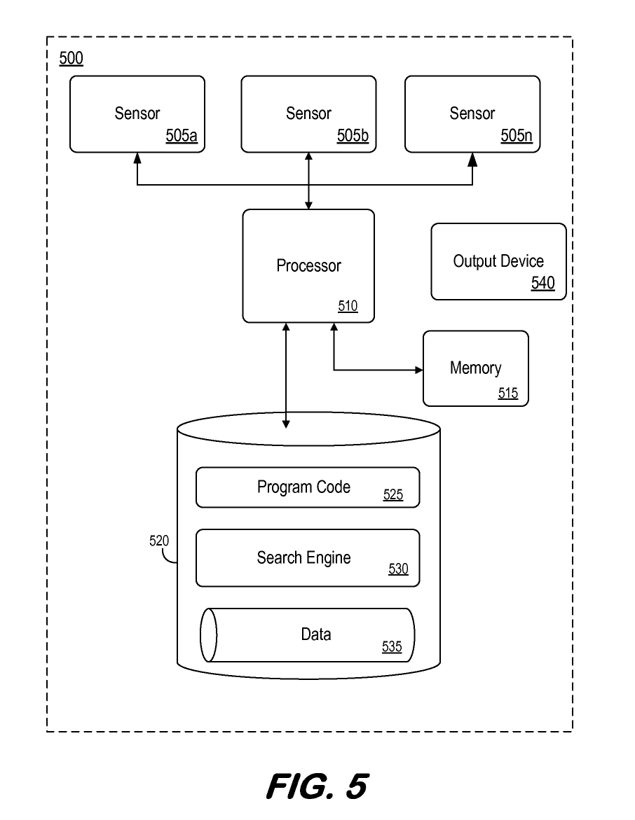

FIG. 5 is a block diagram of a device, system, or apparatus 500 according to some embodiments. System 500 may be, for example, associated with any device to implement the methods and processes described herein, including for example a device including one or more environmental sensors 505a, 505b, . . . , 505n that may provide indications of environmental parameters, either alone or in combination. In some embodiments, system 500 may include a device that can be carried by or worn on the body of a user. In some embodiments, system 500 may be included in a vehicle or other apparatus that can be used to transport a user. System 500 also comprises a processor 510, such as one or more commercially available Central Processing Units (CPUs) in the form of one-chip microprocessors or a multi-core processor, coupled to the environmental sensors (e.g., an accelerometer, a GPS sensor, a speaker, and a gyroscope, etc.). System 500 may also include a local memory 515, such as RAM memory modules. The system 500 may further include, though not shown, an input device (e.g., a touch screen and/or keyboard to enter user input content).

Processor 510 communicates with a storage device 520. Storage device 520 may comprise any appropriate information storage device. Storage device 520 stores a program code 525 that may provide processor executable instructions for processing search and information requests in accordance with processes herein. Processor 510 may perform the instructions of the program 525 to thereby operate in accordance with any of the embodiments described herein. Program code 525 may be stored in a compressed, uncompiled and/or encrypted format. Program code 525 may furthermore include other program elements, such as an operating system and/or device drivers used by the processor 510 to interface with, for example, peripheral devices. Storage device 520 may also include data 535. Data 535, in conjunction with Search Engine 530, may be used by system 500, in some aspects, in performing the processes herein, such as process 200. Output device 540 may include one or more of a display device, a speaker, and other user interactive devices such as, for example, a touchscreen display that may operate as an input/output (I/O) device.

All systems and processes discussed herein may be embodied in program code stored on one or more tangible computer-readable media.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method comprising:
receiving an indication of an environmental context;
receiving a query request;
determining a query result in response to the query request based, at least in part, on the environmental context; and
presenting the query result in a format depending on the environmental context.

2. The method of claim 1, wherein the environmental context is determined based on a signal provided by at least one environmental sensor that senses a velocity, an activity, and a combination thereof.

3. The method of claim 2, wherein the environmental sensor is at least one of a light sensor, a position sensor, a microphone, an accelerometer, a gyroscope, a global positioning satellite sensor, a temperature sensor, a barometric pressure sensor, a proximity sensor, an altimeter, a magnetic field sensor, a compass, an image sensor, a bio-feedback sensor, and combinations thereof.

4. The method of claim 1, wherein the query request may be received as alpha-numeric input, as spoken speech, and a machine readable entry (QR code, bar code, etc.)

5. The method of claim 1, wherein the search result is retrieved via a network interfaced device.

6. The method of claim 1, wherein the determining of the query result is automatically adjusted based, at least in part, on the environmental context.

7. The method of claim 6, wherein at least one of a speed and a detail of the query result is adjusted based, at least in part, on the environmental context.

8. The method of claim 1, wherein the format of the query result presenting is a visual display output, an audible output, and combinations therein.

9. A system comprising:
a machine readable medium storing processor-executable instructions thereon; and
a processor to execute the instructions to:
receive an indication of an environmental context;
receive a query request;
determine a query result in response to the query request based, at least in part, on the environmental context; and
present the query result in a format depending on the environmental context.

10. The system of claim 9, further comprising at least one environmental sensor that provides a signal indicative of a velocity, an activity, and a combination thereof.

11. The system of claim 10, wherein the environmental sensor is at least one of a light sensor, a position sensor, a microphone, an accelerometer, a gyroscope, a global positioning satellite sensor, a temperature sensor, a barometric pressure sensor, a proximity sensor, an altimeter, a magnetic field sensor, a compass, an image sensor, a bio-feedback sensor, and combinations thereof.

12. The system of claim 9, wherein the query request may be received as alpha-numeric input, as spoken speech, and a machine readable entry (QR code, bar code, etc.)

13. The system of claim 9, further comprising a network interfaced device to retrieve the search result.

14. The system of claim 9, wherein the determining of the query result is automatically adjusted based, at least in part, on the environmental context.

15. The system of claim 14, wherein at least one of a speed and a level of detail of the query result is adjusted based, at least in part, on the environmental context.

16. The system of claim 9, wherein the format of the query result presenting is a visual display output, an audible output, and combinations therein.

17. A non-transitory medium having processor-executable instructions stored thereon, the medium comprising:
instructions to receive an indication of an environmental context;
instructions to receive a query request;
instructions to determine a query result in response to the query request based, at least in part, on the environmental context; and
instructions to present the query result, the format of the presenting depending on the environmental context.

18. The medium of claim 17, wherein the environmental context comprises at least a velocity, an activity, and a combination thereof.

19. The medium of claim 17, wherein the determining of the query result is automatically adjusted based, at least in part, on the environmental context.

20. The medium of claim 17, wherein at least one of a speed and a level of detail of the query result is adjusted based, at least in part, on the environmental context.

21. The medium of claim 17, wherein the format of the query result presenting is a visual display output, an audible output, and combinations therein.
